(19) United States
(12) Patent Application Publication
(10) Pub. No.: US 2006/0000256 A1
(43) Pub. Date: Jan. 5, 2006

(54) System for testing performance of medical gas or vapor analysis apparatus

(76) Inventors: Joseph A. Orr, Park City, UT (US); Scott Kofoed, Salt Lake City, UT (US)

Correspondence Address: TRASK BRITT, P.O. BOX 2550, SALT LAKE CITY, UT, 84110, US

(21) Appl. No.: 11/157,182

(22) Filed: Jun. 20, 2005

Related U.S. Application Data
(63) Continuation of application No. PCT/US03/40836, filed on Dec. 22, 2003.
(60) Provisional application No. 60/435,906, filed on Dec. 20, 2002.

(51) Int. Cl. G01N 7/00

(52) U.S. Cl. 73/1.16

(57) ABSTRACT

A test system for assessing the performance of an analyzer for a gas or an anesthetic agent includes a source of a calibration gas mixture, a valve for controlling flow of gas from the source, a low-pressure tube, a sample tube in communication with the low-pressure tube, and a connector for assembling the analyzer to the test system. The test system may also include a valve for diverting ambient air into the sample tube instead of the calibration gas mixture. Additionally, the test system may include one or more of a barometer, a flow meter, an analyzer for gas or anesthetic agents, a flow restriction system, and a relatively high pressure source. Methods for testing analyzers are also disclosed.

### CROSS-REFERENCE TO RELATED APPLICATIONS

This application is a continuation of PCT International Application No. PCT/US2003/040836, filed Dec. 22, 2003, designating the United States of America, and published, in English, as PCT International Publication No. WO 2004/059317 A1 on Jul. 15, 2004, which application claims priority to U.S. Provisional Application No. 60/435,906, filed Dec. 20, 2002, the entire contents of each of which are hereby incorporated herein by this reference.

### TECHNICAL FIELD

The present invention relates to methods and systems for accurately assessing the performance of gas analyzers, such as carbon dioxide monitors and sensors.

### BACKGROUND ART

Clinical practice standards for delivering anesthesia to a patient require that the concentration of carbon dioxide (CO₂) expired by the patient be monitored during all anesthetic procedures in which the respiratory drive of the patient (i.e., the patient's ability to breathe on his or her own) may be impaired. Typically, gas analyzers, such as carbon dioxide monitors and sensors (which sensors are also referred to as “capnometers”), are used to monitor the concentration of CO₂ expired by an anesthetized patient.

In addition to monitoring CO₂ levels, many hospitals employ gas analyzers which are configured to monitor, in real time, the amount of anesthetic agents (e.g., gases, vapors, etc.) that an anesthetist is delivering to the patient.

Gas analyzers measure the amount (typically in terms of partial pressure) of a specific gas (CO₂ in the case of capnometers) that is in a respiratory sample. There are currently two major types of gas analyzers that have found widespread use: (1) the so-called “mainstream,” or “on-airway,” type, which is positioned along a breathing circuit that communicates with the airway (i.e., trachea, bronchi, and lungs) of a patient to measure the amount of a particular gas in respiration that passes through the breathing circuit; and (2) the “so-called” side stream type, or sampling system, which includes a sensor that is positioned somewhat remotely from the breathing circuit and communicates therewith by way of one or more sample tubes, through which small samples of gases that are inhaled and exhaled by a patient are diverted to the sensor for analysis. Side stream sampling systems are also typically configured to draw the samples from the breathing circuit and to remove moisture from, or dry, a sample prior to presenting it to the sensor at a known and controlled pressure and flow rate.

Sometimes, gas analyzers are tested by passing a calibration gas or calibration gas mixture, which includes one or more gases or other constituents (e.g., CO₂, gaseous or vaporized anesthetic agents, etc.) of known concentration therethrough. The amount or amounts of each evaluated gas or other constituent is then compared with the known amount of that constituent in the calibration gas. While this technique is sometime effective for measuring the performance of a gas analyzer, it is not always reliable, as the rate at which the calibration gas or calibration gas mixture flows through the gas analyzer may cause the gas analyzer to provide unreliable results. Further, due to excessive flow and failure to terminate the flow of calibration gases when the test is complete, calibration gases are often wasted when this type of technique is employed.

Moreover, while the amounts of the constituents in calibration gases have conventionally been measured in terms of the percent, by volume, they constitute of a given volume of a precisely controlled calibration gas mixture (e.g., 5% CO₂, 16% O₂, balance N₂ being common), such percentages do not readily translate to the units of gas concentrations that are typically measured by gas analyzers. Specifically, most gas analyzers are designed to evaluate the partial pressure (e.g., mm Hg in U.S., kilopascals in Europe) of a particular gas in a sample.

Further, the monitors that are associated with most capnometers (i.e., CO₂ analyzers) are designed to evaluate monitored data and report end-tidal gas concentrations in partial pressures, which are typically defined in terms of millimeters of mercury (mm Hg). End-tidal CO₂, which occurs near the end the expiratory phase of a subject's respiration, or breathing, is the highest CO₂ concentration observed during a breath. Conventional techniques for calibrating capnometers, however, involve metering of a calibration gas mixture from a tank at a constant flow rate. Thus, the signal produced by a capnometer does not simulate the ebbs and flows of breathing, and no end-tidal value is reported. As a result, one must know how to cause the monitor associated with the capnometer to evaluate signals from the capnometer in an “instantaneous concentration” mode. Many of the currently available monitors require that a recalibration sequence be initiated to continuously evaluate constant concentrations of an analyzed gas, which may be undesirably time-consuming.

It is also often difficult to consistently maintain the precise gas proportions of calibration gas mixtures for use with gas analyzers that are used in evaluating the amount of anesthesia present in a sample. This difficulty is caused, at least in part, by the condensation of anesthesia gases at relatively low pressures. In order to provide an anesthesia calibration gas mixture having accurate sample concentrations, the anesthesia gases must be stored at very low pressures. This means that only small amounts of anesthesia calibration gases may be stored in cylinders of conventional sizes, which results in the availability of undesirably small samples of undesirably large storage tanks.

Another challenge of maintaining anesthesia calibration gas mixtures is their typically short shelf lives.

In addition, calibration gases, including those configured for use with carbon dioxide analyzers and anesthesia analyzers, are often delivered at excessive flow rates, which may result in wastage thereof.

In view of the foregoing, there is a need for a system and method by which a gas analyzer may be tested or calibrated accurately, relatively quickly and conveniently, and without wasting a calibration gas mixture.

### DISCLOSURE OF INVENTION

The present invention includes a system for testing or calibrating a gas analyzer, such as a capnometer, an anesthesia analyzer, or the like, as well as testing and calibration methods. Despite being useful for both testing and calibration, systems that incorporate teachings of the present invention are referred to herein as “test systems” for the sake of simplicity.

A test system according to the present invention may be used with both main stream and side stream gas analyzers. Calibration gas mixtures with known amounts of one or more gases (or vapors) may be used to evaluate the accuracy of both types of gas analyzers. The frequency response, a measure of how quickly a gas analyzer detects a change in the amount of one or more gases in a sample (e.g., a respiratory sample, a calibration gas mixture, etc.), of both types of gas analyzers may also be evaluated. In addition, the ability of a side stream gas analyzer to draw a sample from a breathing circuit may also be evaluated by use of a test system of the present invention.

An exemplary embodiment of test system that incorporates teachings of the present invention includes at least one tank within which a calibration gas mixture is held. A calibration gas line may be in communication with each tank to facilitate the removal of a calibration gas mixture therefrom. A pressure sensor and a pressure regulator communicate with tank, as does a flow control valve, and each of these elements may be positioned along the calibration gas line. The pressure regulator and flow control valve are located and configured to control flow of the calibration gas mixture from the tank. On an opposite side of the flow control valve, each calibration gas line communicates with a low pressure tube, or “low flow tube,” which ventilates to ambient, or “room,” air. A flow restriction system, which may include one flow restriction line or a series of flow restriction lines, may communicate with the low-pressure tube, downstream from the flow control valve. A valve and, optionally, a flow restrictor may be positioned along each flow restriction line. Further downstream, the test system includes a sample tube that communicates with the low pressure tube. If the test system includes a flow restriction system, communication between the sample tube and the low pressure tube may occur through the flow restriction system. A diversion valve is positioned along the sample tube. The diversion valve is configured to control the flow of ambient, or room, air into the sample tube. Thus, by operation of the diversion valve, the calibration gas mixture may be diluted with or replaced with ambient air. The sample tube includes a connector, or adapter, which is configured to connect a gas analyzer to be tested, which is also referred to herein as a “unit under test,” to the test system. Optionally, a flow meter of a known type may be positioned between the diversion valve and the connector.

In addition, the test system may include one or more processing elements (e.g., processors, computers, etc.) that are configured to communicate with the pressure regulator, flow control valve, and diversion valve thereof. The at least one processing element may be configured to control the flow of a calibration gas mixture from tank, as well as to automatically shut off the flow of the calibration gas mixture once testing has been completed or after a predetermined period of time, thereby preventing accidental emptying of the calibration gas mixture from its respective tank. Communication between the tank and the low pressure tube may also be terminated when the pressure sensor indicates to the at least one processing element that the calibration gas mixture is no longer flowing, which may prevent loss of calibration gas as a new tank is placed in communication with the calibration gas line.

The one or more processing elements of the test system may also be configured to communicate with and receive signals from the unit under test and the flow meter, if any.

Additionally, the test system may include a barometer that communicates with at least one processing element that also communicates with the device under test. This arrangement facilitates the accurate calculation of partial pressures that correspond to the concentration of one or more gases or vapors included in the calibration gas mixture.

In another example of a test system that incorporates teachings of the present invention, the flow control valve comprises a three- or more-way valve with at least two inlets and one outlet. In addition to controlling communication between the tank and the low pressure tube, the flow control valve of this embodiment controls communication between an air pump and the low pressure tube. The one or more processing elements may communicate with and control operation of one or both of the flow control valve and the air pump such that the calibration gas mixture may be delivered to the remainder of the test system in such a way as to mimic a subject's (e.g., a patient's) breathing.

The present invention also includes methods for testing and calibrating gas analyzers by assembling or otherwise placing the same in communication with a test system that incorporates teachings of the present invention and operating the test system in accordance with a desired test or calibration protocol, which are also within the scope of the present invention. Examples of test methods include methods for testing the accuracy of a gas analyzer, testing the responsiveness of a gas analyzer to changes in the amounts of a gas or vapor that are present in an evaluated sample, and testing the ability of the gas analyzer to respond to changes in the airway pressure of a subject.

Other features and advantages of the present invention will become apparent to those of ordinary skill in the art through a consideration of the ensuing description, the accompanying drawing, and the appended claims.

### BRIEF DESCRIPTION OF THE DRAWINGS

Various aspects of exemplary embodiment of test systems according to the present invention are shown in the drawings, in which:

FIG. 1 is a schematic representation of an exemplary embodiment of test system; and

FIG. 2 schematically depicts another exemplary embodiment of test system, including an air pump that mimics a subject's breathing.

### DETAILED DESCRIPTION OF THE INVENTION

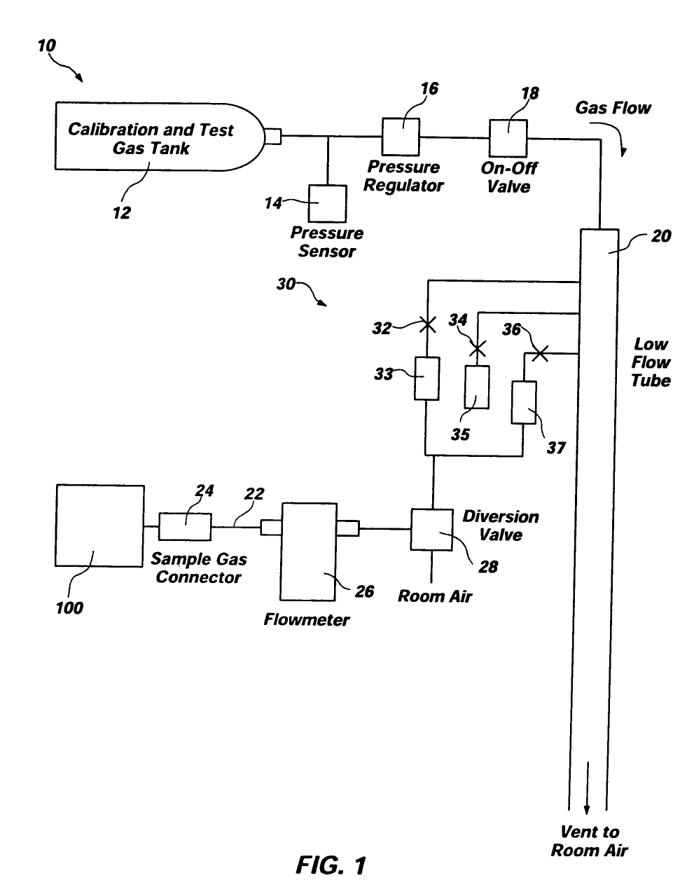

FIG. 1 depicts an exemplary embodiment of test system 10 for gas analyzers. Test system 10 comprises a “smart tank” and is configured to test or calibrate a device under test 100, such as a capnometer, other gas analyzer, or anesthesia analyzer. As depicted, test system 10 includes a tank 12 and various conduits, sensors, regulators, valves, and flow restrictors to provide a complete system for verifying that device under test 100 is functioning correctly or for calibrating device under test 100. Additionally, one or more processing elements 50 may control operation of one or more of the other elements of test system 10 and, if processing elements 50 control operation of more than one other element of test system 10, synchronize operation of the elements.

Test system 10 employs a tank 12 of a known type (e.g., a conventional cylinder-type tank) which contains a precision blended calibration gas mixture for use in testing or calibrating device under test 100. The pressure within tank 12 may be measured electronically, such as by the depicted pressure sensor 14, which communicates with tank 12 and comprises a pressure sensor of a known type.

A pressure regulator 16 of a known type is positioned downstream from pressure sensor 14 and may regulate the pressure of the calibration gas mixture downwardly, as desired (e.g., to less than about 1 psig). It is currently preferred that pressure regulator 16 be set to deliver the calibration gas mixture at a pressure that exceeds the ambient (e.g., atmospheric) pressure in the environment in which test system 10 is being used. Pressure regulator 16 may also be operated in a manner that will not cause the calibration gas mixture to be delivered to unit under test 100 at a pressure which is substantially different from the ambient pressure. Pressure sensor 14 and pressure regulator 16 may both be in communication with a processing element 50 of test system. Pressure sensor 14 may communicate pressure signals to processing element 50. Processing element 50 may then, under control of programming thereof and based on the pressure signals that have been received from pressure sensor 14, control operation of pressure regulator 16.

A flow control valve 18 is positioned so as to control the flow of the calibration gas mixture from tank 12. Flow control valve 18 may comprise any suitable valve of known type and may be manually, mechanically, or electronically actuated. By way of example only, flow control valve 18 may communicate with a processing element 50 of test system 10. Thus, operation of flow control valve 18 may be under control of programming of processing element 50.

After passing through flow control valve 18, the calibration gas mixture flows into a low pressure tube 20. Once the calibration gas mixture enters low pressure tube 20, the pressure to which the calibration gas mixture is subjected is decreased to substantially ambient (e.g., atmospheric) pressure.

Optionally, from low pressure tube 20, the calibration gas mixture may flow into a flow restriction system 30. As shown, flow restriction system 30 includes three flow restriction lines 31, 34, 37, although flow restriction systems with only a single flow restriction line or other numbers of flow restriction lines are also within the scope of the present invention. A valve 33, 36, 39 is respectively associated with each flow restriction line 31, 34, 37 to control the flow of the calibration gas mixture therethrough. Valve 33, 36, 39 may communicate with and be under control of programming of a processing element 50, as known in the art. Valve 33, 36, 39 may be configured to function between full-opened and full-closed positions in a plurality of intermediate positions (e.g., continuously or incrementally), which facilitates selection in an amount of resistance along flow restriction line 31, 34, 37 that simulates a desired level of occlusion in a sample line through which gases are conveyed to a side stream-type unit under test 100. Alternatively, valve 33, 36, 39 may be configured to either completely open or to completely close the respective flow paths through restriction line 31, 34, 37. If a valve 33, 36, 39 is configured to only open completely or close completely, a flow restrictor 32, 35, 38 may be positioned along (within) each flow restriction line 31, 34, 37, with flow restrictors 32, 35, and 38 restricting the flow of the calibration gas mixture to differing degrees to simulate various levels occlusion in a sample line through which gases are conveyed to a side stream-type unit under test 100.

Test system 10 also includes a sample tube 22, which communicates with low pressure tube 20. If test system 10 also includes a flow restriction system 30, sample tube 22 may be positioned downstream from flow restriction system 30 and communicate indirectly with low pressure tube 20 through flow restriction system 30.

A diversion valve 28 is positioned along sample tube 22. Diversion valve 28, which is at least a three-way valve including at least two inlets and a single outlet, is configured to select from gases with an upstream portion 22u of sample tube 22, external ambient air, or a combination thereof and to permit flow of the selected gases to a downstream portion 22d of sample tube 22. If diversion valve 28 is intended to permit the calibration gas mixture and ambient air to simultaneously flow into downstream portion 22d of sample tube 22, it may be configured to have a variety (e.g., incremental or continuous) of inlet positions (i.e., both inlets of diversion valve 28 may be partially open at the same time). Alternatively, diversion valve 28 may be configured to be selectively disposed in one of only two inlet positions (e.g., from upstream portion 22u of sample tube 22 or from the environment in which test system 10 is located). Of course, positioning of either type of diversion valve 28 may be controlled manually or automatically, under control of suitable programming of a processing element 50 in communication therewith.

In use, diversion valve 28 may be switched between the two sources (i.e., upstream portion 22u of sample tube 22 and the environment in which test system 10 is located) at a frequency or combination of frequencies that simulates a variety of breath rates. Such switching may, by way of example only, be effected under control of processing element 50. By switching diversion valve 28, the frequency response of unit under test 100 may be evaluated (e.g., by a processing element 50 of test system 10).

Optionally, a side stream or main stream flow meter 26 of a known type (e.g., differential flow, spinning vane, hot wire anemometers ultrasonic Doppler, vortex shedding, time of flight, etc.) may be positioned along sample tube 22, downstream from diversion valve 28. Flowmeter 26 may be configured to measure the rate at which gases (e.g., the calibration gas mixture, ambient air, or a combination thereof) flow through sample tube 22 and into unit under test 100.

As another alternative, flowmeter 26 may comprise a combined gas/flow sensor of a known type, such as the NICO® CO₂/flow sensors available from Respironics, Inc. of Murraysville, Pa. Alternatively, a separate analyzer (e.g., a gas analyzer, anesthetic agent analyzer, etc.) may be included along sample tube 22. Inclusion of such an analyzer in test system 10 may be useful for providing a user of test system 10 with information about whether or not the calibration gas mixture being used with test system 10 includes appropriate constituents and constituent amounts for evaluating or calibrating a particular unit under test 100. For example, if unit under test 100 is a carbon dioxide analyzer, but the concentration of carbon dioxide in the calibration gas mixture is unacceptably high or low (or nonexistent), the analyzer (e.g., an analyzer of flowmeter 26) may indicate the possibility that a calibration gas mixture which is inappropriate for evaluation of unit under test 100 may be used in test system 10. Such a determination may be made by a processing element 50 in communication with the analyzer, which processing element 50 may then indicate the possibility of an inappropriate calibration gas mixture to a user of test system 10 or require the user to check and replace the calibration gas mixture.

A connector 24, or adapter, is positioned at a downstream end 23d of sample tube 22 to facilitate connection of a unit under test 100, such as a side stream type gas analyzer, to downstream end 23d and, thus, to facilitate communication between sample tube 22 and unit under test 100. Connector 24 may be configured to generate signals indicative of whether or not a unit under test 100 has been properly assembled therewith and to transmit such signals to a processing element 50 of test system 10.

Test system 10 may also include a barometric pressure sensor, or barometer 29, of a known type. Barometer 29 may communicate measurements of the ambient barometric pressure of the environment within which test system 10 is located to a processing element 50 of test system 10. Alternatively, such information may be manually obtained by a user of test system 10. A barometric pressure measurement obtained with barometer 29 is used, as known in the art, to convert the volume percentages of the calibration gas mixture within tank 12 to partial pressure measurements. The partial pressure of each gas of the calibration gas mixture within tank 12 may then be displayed to the user for comparison with one or more corresponding partial pressure values obtained with unit under test 100.

With continued reference to FIG. 1, an example of the use of test system 10 is described. Prior to use of test system 10, or at any other time test system 10 is not in use, flow control valve 18 should be in a closed position, preventing a calibration gas mixture within tank 12 from flowing or leaking therefrom. If gas flow is detected by flowmeter 26 when test system 10 is not being used (e.g., when a unit under test 100 is not assembled with connector 24 of test system 10), programming (e.g., computer logic) of processing element 50, which communicates with flowmeter 26 and flow control valve 18, may cause flow control valve 18 to completely close. Such programming will greatly decrease the amount of costly calibration gas mixtures that are wasted.

Processing element 50 may likewise be programmed to control one or both of pressure regulator 16 and valve 18 in such a way as to control the amount of calibration gas mixture that is released from tank 12 into the remainder of test system 10 and, thus, to optimize the efficiency with which the calibration gas mixture is used.

When test system 10 is to be used, a gas analyzer to be tested, or a unit under test 100, is secured to test system 10 by way of adapter 24. A tank 12 including a desired calibration gas mixture may also be assembled with the remainder of test system 10. Thereafter, flow control valve 18 is opened, permitting the calibration gas mixture to flow into low pressure tube 20, where the pressure of the calibration gas mixture is reduced substantially to atmospheric or ambient pressure. The calibration gas mixture may then be drawn or forced into sample tube 22, where it flows into unit under test 100. When it operates, unit under test 100 provides the user of test system with data regarding the amount (e.g., partial pressure) of one or more substances in the calibration gas mixture, which may then be compared, manually or automatically (e.g., by a processing element 50), with the known amount of each substance in the calibration gas mixture.

Optionally, flow restriction system 30, if any, may be used to determine whether or not unit under test 100 responds as designed in the presence of a change in patient airway pressure and provides some sort of alarm (e.g., audible, visual, etc.) in the presence of an occluded sample line. Valves 33, 36, 39 on restriction lines 31, 34, 37 may be actuated such that their corresponding flow restrictions 32, 35, 38 simulate various levels of sample line occlusion. Ideally, unit under test 100 will hold a constant flow and will continue to measure the correct gas concentration during all levels of occlusion that do not trigger an alarm condition.

If unit under test 100 does not measure the amount or amounts of one or more gases in the calibration gas mixture with a desired degree of accuracy, unit under test 100 may be set aside for calibration or discarded.

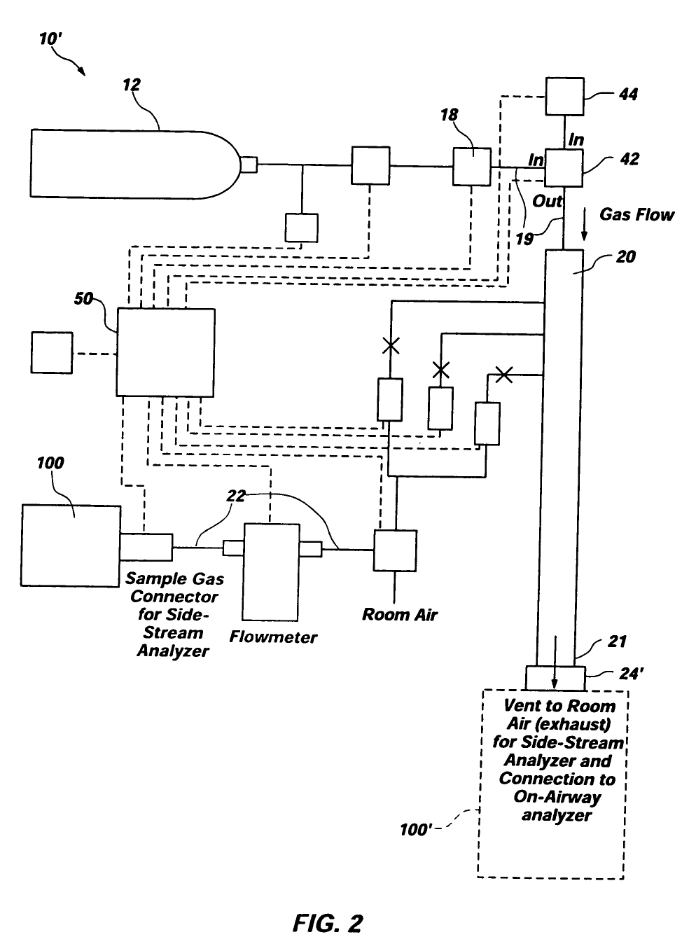

Turning now to FIG. 2, another exemplary embodiment of test system 10′ that incorporates teachings of the present invention is illustrated. Test system 10′ resembles test system 10 (FIG. 1), but more amenable than test system 10 to being used in testing mainstream type gas sensors (e.g., capnometers, sensors for other types of gases, anesthesia sensors, etc.).

In particular, test system 10′ includes a three-way valve 42 in communication between (e.g., along a supply tube 19) flow control valve 18 and an upstream end 21u of low-pressure tube 20. As shown, three-way valve 42 includes two inlets, one which receives gases from the outlet of flow control valve, the other inlet communicating with a relatively high pressure source 44. The same calibration gas mixture that flows from tank 12 or a different gas mixture (e.g., air) may be forced into test system 10′ by way of relatively high pressure source 44. The outlet of three-way valve 42 communicates with low-pressure tube 20.

Test system 10′ also includes a connector 24′ at a downstream end 21 of low-pressure tube 20. Connector 24′ is configured to facilitate assembly of a mainstream, or on-airway, analyzer 100′ of known type (e.g., a capnometer, another gas analyzer, an anesthetic agent analyzer, etc.) to low pressure tube 20 of test system 10′.

Relatively high pressure source 44 of test system 10′ may comprise an air pump of a known type (e.g., an electric air pump under control of programming of a processing element 50 of test system 10′, a tank or other source of compressed air or gas, etc.).

Three-way valve 42 maybe electronically (e.g., under control of programming of a processing element 50), mechanically, or manually actuated, to completely or partially select from the two inlets thereof. Thus, three-way valve 42 facilitates control over introduction of one or both of the calibration gas mixture from tank 12 and pressurized gas or air from relatively high pressure source 44 into the remainder of test system 10′. Switching between relatively high pressure source 44 and tank 12 at various frequencies may simulate various breath rates and create a flow in low-pressure tube 20 that simulates a patient's breathing. The simulated breathing may then be observed within low-pressure tube 20 or sample tube 22.

Test system 10′ may, by way of example only, be used in the same manner that has been described above with respect to test system 10. When unit under test 100 is, for example, a side-stream analyzer, three-way valve 42 may be positioned to accept the calibration gas mixture directly from tank 12. If unit under test 100 is a mainstream type sensor, three-way valve 42 may be repeatedly switched to cause the calibration gas mixture from tank 12 and gases under pressure from relatively high pressure source 44 to flow through the remainder of test system 10′ in an alternating fashion and in a manner which simulates a patient's breathing.

Although the foregoing description contains many specifics, these should not be construed as limiting the scope of the present invention, but merely as providing illustrations of some of the presently preferred embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

What is claimed:

1. A method for testing an accuracy of an analyzer for measuring at least one of a gas and an anesthetic agent, comprising:
securing the analyzer to a test system;
converting a known amount of at least one gas or anesthetic agent of a calibration gas mixture to be used in testing the analyzer to a partial pressure by use of a barometric pressure measured in an environment in which the test system is located;
introducing the calibration gas mixture into the test system;
reducing a pressure on the calibration gas mixture; and
comparing an amount of the at least one gas or anesthetic agent measured by the analyzer to the partial pressure of the at least one gas or anesthetic agent.

2. The method of claim 1, further comprising:
altering gas flow to the analyzer to simulate gases sampled during inspiration and expiration of a patient.

3. The method of claim 2, wherein altering gas flow comprises actuating a diversion valve downstream from a location where reducing the pressure of the calibration gas mixture is effected.

4. The method of claim 1, wherein introducing the calibration gas mixture comprises pressurizing gases within the test system in such a way as to simulate breathing of a patient.

5. The method of claim 4, wherein pressurizing gases within the test system comprises switching a source of gases supplied to the analyzer between a source of the calibration gas mixture and a source of pressurized gas.

6. The method of claim 5, wherein switching is effected with at least one valve.

7. The method of claim 5, wherein switching is effected at a plurality of different rates so as to simulate a plurality of breathing rates.

8. The method of claim 1, further comprising:
simulating a flow obstruction along at least one of a breathing circuit and a sample tube.

9. The method of claim 8, wherein simulating the flow obstruction comprises restricting flow through the test system.

10. The method of claim 1, further comprising:
monitoring flow of gases through the test system.

11. The method of claim 10, further comprising:
determining whether or not the analyzer is properly assembled with the test system.

12. The method of claim 11, further comprising:
terminating flow of the calibration gas mixture if the analyzer is not properly assembled with the test system.

13. The method of claim 10, further comprising:
optimizing a flow of the calibration gas mixture to conserve the calibration gas mixture.

14. The method of claim 1, further comprising:
analyzing at least one component of the calibration gas mixture to determine whether or not a correct amount of at least one gas is present in the calibration gas mixture.

15. The method of claim 14, further comprising:
replacing the calibration gas mixture if the correct amount of the at least one gas is not present therein.

16. A system for determining an accuracy of an analyzer for measuring at least one of a gas and an anesthetic agent, comprising:
a source of a calibration gas mixture;
a valve for controlling flow of the calibration gas mixture from the source into a remainder of the system;
a low-pressure tube for receiving the calibration gas mixture and reducing a pressure on the calibration gas mixture to about an ambient pressure of an environment within which the system is located;
a sample tube in communication with the low-pressure tube; and
a connector on a downstream end of the sample tube for connecting the analyzer to the sample tube.

17. The system of claim 16, further comprising:
at least one processing element in communication with the valve for controlling flow and configured to operate under control of programming.

18. The system of claim 16, further comprising a barometer.

19. The system of claim 16, further comprising:
a relatively high pressure source; and
another valve for controlling pressure within the system located downstream from the valve for controlling flow and positioned between the valve for controlling flow and the low-pressure tube, the valve for controlling pressure being configured to select from at least one of the source of the calibration gas mixture and the relatively high pressure source.

20. The system of claim 19, wherein the relatively high pressure source comprises at least one of a pump and a source of compressed gas.

21. The system of claim 19, wherein the valve for controlling pressure communicates with and operates under control of at least one processing element.

22. The system of claim 16, further comprising:
a valve for diverting ambient air into the test system positioned upstream from the sample tube.

23. The system of claim 22, wherein the valve for diverting ambient air operates under control of at least one processing element in a manner that causes the calibration gas mixture and ambient air to be introduced into the sample tube in an alternating manner.

24. The system of claim 23, wherein the at least one processing element is programmed to operate the valve for diverting ambient air in a manner that simulates inspiration and expiration by a subject.

25. The system of claim 16, further comprising:
a flowmeter positioned along the sample tube.

26. The system of claim 16, further comprising:
an analyzer for at least one of a gas and an anesthetic agent positioned along the sample tube.

27. The system of claim 16, further comprising:
a flow restriction system in communication with the low-pressure tube.

28. The system of claim 27, wherein the flow restriction system includes at least one restriction line with at least one valve located so as to control flow of gases through the at least one restriction line.

29. The system of claim 28, wherein the flow restriction system further includes at least one flow restrictor located so as to restrict flow of gases through the at least one restriction line.

30. The system of claim 28, wherein the at least one restriction line comprises a plurality of restriction lines.
